(19) United States
(12) Patent Application Publication
(10) Pub. No.: US 2012/0143698 A1
(43) Pub. Date: Jun. 7, 2012

(54) METHOD FOR PEOPLE TO GET ACQUAINTED WITH ONE ANOTHER

(76) Inventor: Remon Machiel Van Der Heide, Eindhoven (NL)

(21) Appl. No.: 13/386,807

(22) PCT Filed: Sep. 15, 2010
(86) PCT No.: PCT/NL2010/050592

§ 371 Date: Feb. 24, 2012

(30) Foreign Application Priority Data
Jul. 24, 2009 (NL) 2003 289

(51) Int. Cl. G06F 15/16; G06Q 30/02

(52) U.S. Cl. 705/14.66; 709/219

(57) ABSTRACT

A method for people to get acquainted with one another comprises the following steps:
facilitating access with an electronic appliance via the internet to a central database for putting in personal profiles:
facilitating access with a mobile communication device via the internet to a central server which is coupled to the central database, for putting in selection criteria;
facilitating downloading applications via the internet to a mobile communication device for selecting people and for navigation purposes;
selecting logged-on people in the database;
facilitating the possibility of logging on to the central server with a mobile communication device;
computing the location of the mobile communication device from which the selection criteria have been sent and of the selected people,
sending navigation information to the mobile communication device,
installing routers in a room,
linking the routers to a local server, and
linking the local server to the central server through the internet,
   wherein:
facilitaing the possibility of logging on is effected by facilitating this log-on via the routers on the basis of WiFi technology and via the local server,
computing the locations is effected in the local server on the basis of data received from these communication devices via the routers, which data are about WiFi signals received by these communication devices, and
sending navigation information to the mobile communication device is effected via the WiFi technology routers and the local server.

### FIELD OF THE INVENTION

The invention relates to a method for people to get acquainted with one another, which method comprises:
facilitating access with an electronic appliance via the internet to a central database for putting in personal profiles:
facilitating access with a mobile communication device via the internet to a central server which is coupled to the central database, for putting in selection criteria for selecting people on the basis of the personal profiles;
facilitating downloading applications via the internet to a mobile communication device for selecting people and for navigation purposes;
selecting logged-on people from the database on the basis of selection criteria and personal profiles that have been put in;
facilitating the possibility of logging on to the central server with a mobile communication device;
computing the location of the mobile communication device from which the selection criteria have been sent and of the selected people, and
sending navigation information to the mobile communication device from which the selection criteria have been sent.

The idea of people getting acquainted with one another may be thought of as a possibility of establishing friendly relations, business contacts etc.

### STATE OF THE ART

A method of this type is known from US 2007/28262 A1. In this known method GSM technology is used. A disadvantage is in this case that the positioning of the mobile telephones is not very accurate, so that this method is unsuitable for matching people in a hall or building during a conference. At such conferences one is first to make contact with each person to find out whether this person could be of interest.

### SUMMARY OF THE INVENTION

It is an object of the invention to provide a method for matching people present in a hall or in a building. For this purpose the method according to the invention is characterized in that the method further includes the following steps of:
installing routers in a room,
linking the routers to a local server, and
linking via the internet the local server to the central server to which the central database is coupled,
   wherein:
facilitating the possibility of logging on to the central server by means of a mobile communication device is effected by facilitating this log-on via the routers on the basis of WiFi technology and via the local server,
computing the location of the mobile communication device from which the selection criteria have been sent and of the selected people is effected in the local server on the basis of data received from these communication devices via the routers, which data are about WiFi signals received by these communication devices, and
sending navigation information to the mobile communication device from which the selection criteria have been sent is effected via the WiFi technology routers and the local server.

Before you contact a person in the hall or the building you can first select in advance which persons could be suitable for selection. As a result, you can make contact in a more purpose-oriented way and thus increase the chance of success.

The method according to the invention preferably further includes the step of asking the person concerned via the communication device for a remuneration for selection and navigation and the automatic cashing of the remuneration via an automatic pay system.

An embodiment of the method according to the invention is characterized in that the method further includes the step of facilitating the option of a logged-on person being able to exclude a person from a next selection who has once been spoken to.

A further embodiment of the method according to the invention is characterized in that the method further includes the step of installing picture screens at various locations in the room and displaying on these screens commercials or messages tailored to the profile of the logged-on person who is present in the neighbourhood of the screen. For example, somebody goes to the lavatory. To date a man has kept staring at a blank wall there. On the basis of the person's data purpose-oriented advertising will now be displayed via a picture screen. This may also be achieved in restaurants or other places where people come together. The routers spot a mobile communication device. The profile of its user is known and specific information can be displayed on the picture screen where this user is located.

Yet another embodiment of the method according to the invention is characterized in that the method further includes the step of sending banners tailored to the profile of the respective person to the mobile communication device of this person.

### BRIEF DESCRIPTION OF THE DRAWING FIGURE

The invention will be further described below in more detail with reference to an example of embodiment shown in the drawing FIGURE of the method for people to get acquainted with one another, which method is according to the invention and in which drawing FIGURE:

FIG. 1 systematically shows a system with which the method according to the invention can be carried out.

### DETAILED DESCRIPTION OF THE DRAWING FIGURE

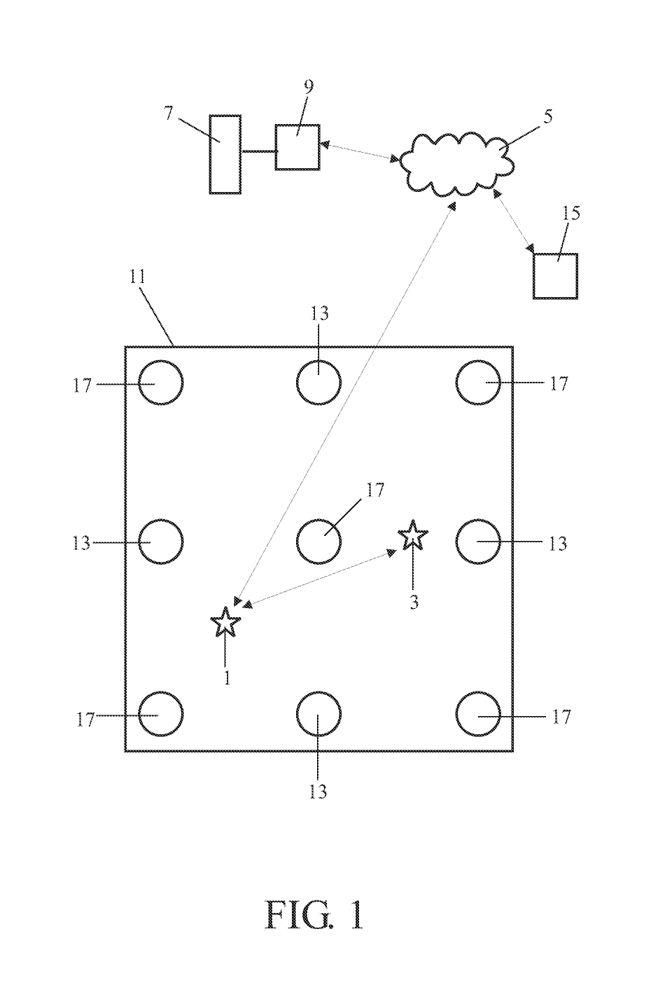

With a first embodiment of the method according to the invention a user may network with his own mobile communication device, such as for example a gsm, pda or smartphone. The user 1, 3 (see FIG. 1) first makes a profile sketch of himself via the internet on an internet site specially arranged for this purpose, which sketch contains his own primary and secondary features. After completion the profile sketch of the user is complete and may be used at different locations throughout The Netherlands and beyond. So there is a central database 7 which is coupled to a central server 9 and in which data from users 1, 3 are stored. The database 7 is filled with information (profiles) via the web site by the users themselves. On location, various routers 13 and a local server 15 will be installed in a space 11 (inside space or outside space). These routers 13 are placed on the local server 15 on a map that cooperates with the application that computes where every system user is present at that very location. The routers 13 are used for granting access to the system to users and for giving access to the web site of the system. This provides that people are connected to the system that is locally available.

Furthermore, measuring routers 17 will be installed in the space 11 for carrying out the measurements. These measuring routers 17 are adapted to the applications used both as regards technical possibilities and as regards external features.

The measured values only consist of the various network names of the measuring routers and the dedicated signal strengths. The obtained measured values are subsequently passed on to the local server 15 which computes the position of the mobile communication device of the users 1, 3 from the received measured values and the map on which it is established which measuring router is placed at what position.

For the purpose of navigating the users, data about the location of the mobile communication device of the searching user 1 and the mobile communication device of the user 3 who is to be found are to be retrieved from the local server and after that be represented on the mobile communication devices. Consequently, the users 1, 3 will be navigated towards each other. The navigation works through the routers 13 which are installed in the room 11. The method can only be implemented by people who are located within the predetermined room.

An application will have to be downloaded only once, which application is coupled to the control system of the user's mobile communication device (preferably containing WiFi). This may be effected on location, but also from one's home. Once the application is available in the user's mobile communication device, the user can utilize the ‘coupling’ between himself and other people present anywhere at any location. A built-in payment system will automatically provide that an amount of money will be charged by direct debit. This amount stands for making use a single time of the full navigation service until a meeting has ensued.

From all the people present who are logged on, their profile sketches can be watched without photographs. By means of filtering (company name, size of the company, number of employees, branch of industry, interests etc.) one may end up at the right person one physically wishes to speak. After filtering, a number of people (a maximum of 10 and adjusted to the display screen as regards readability of the relevant communication device) will be imaged who will come closest to the put-in selection criteria. Subsequently, it is possible to click one's own communication device to indicate the person one wishes to have a physical conversation with. After confirmation of the choice and the acceptance of the general conditions and automatic payment, one will subsequently be navigated to the person one wishes to speak. At that moment the photographs of the best matches are in view indeed.

As an option is included that a person receives an announcement before somebody wishes to speak with him. When this announcement is acknowledged, these people will be navigated by means of interactive algorithms to an accuracy of half a metre's distance to the person one wishes to speak with. Subsequently, a physical discussion takes place for as long as one wishes. This can only be effected where the routers are installed temporarily or permanently.

So there is an application that runs on the mobile communication device and with which one can log on to the central database (this application can also be downloaded at home provided that there is a router available there). With this application it is possible to search and filter the central database to select profiles. This application includes a payment system that pays on account in accordance with a specific protocol. This application also includes a navigation system that navigates the user to the selected person.

Once the conversation has been terminated, either party can put in whether the conversation was agreeable or not. One simply ticks one's telephone whether one wishes to have this person show up again within the filtering at a next meeting. A person one has already spoken with will not be met again within the filtering with a new search instruction, unless otherwise indicated. On one's own desktop or laptop at home it is possible to make notes about the person spoken with, as an addition to one's own profile. So it is possible to note down anything that turned out to be important from the conversation held.

At various points within the locations which are provided with the systems for implementing the method, additional measuring routers 17 will be installed so that 100% goal-oriented advertising will be a fact and is fully matched with the profile of each person. For example, somebody goes to the lavatory. To date a man has kept staring at a blank wall there. On the basis of a person's data, goal-oriented advertising will now be displayed via a picture screen. This can also be achieved in restaurants or other spaces where people meet. The measuring routers 17 spot an address coupled to each mobile communication device. The profiles are known and specific information can be displayed at various locations.

Furthermore, at any moment it is possible for banners from other companies to be displayed on the mobile communication devices of the users or even at home when they watch their own profiles. This information too is tailored to their interests.

If the logged-on people are no longer present in the room where there is reception, he or she will no longer be traceable until he or she returns. For example, it will not be possible to find somebody who goes to the lavatory for the duration he or she is in that facility.

A great attraction of the method according to the invention is the fact that users also have to fill in their secondary data, so that hobbies etcetera may work as ice-breaking information. To a lot of people applies the fact that they are not sufficiently verbally skilled to go up to a person without a blush. Predetermined information about a person concerned will certainly break the ice to strike up a conversation. For that matter one is no longer introduced in a roundabout way.

Participants to business clubs (permanent or incidental meetings), seminars, meetings of lawyers, single people, visitors to festivals for more than one day (indoor and outdoor), large companies facilitating an intranetwork, etcetera; any conceivable large meeting (for example dance parties) may be used for implementing the method according to the invention.

For personalized advertising could be used picture screens that can be installed anywhere at the locations. They may be installed permanently or incidentally. It is possible for these picture screens to show purpose-oriented advertising or non-commercial messages. These picture screens have an integrated receiver for WiFi use and a motherboard for data storage.

It frequently happens that shop assistants are asked by clients where certain products are to be found in the shop. This is time-consuming for the shop assistants and they may carry on with their current jobs in a less concentrated manner. With another embodiment of the method according to the invention all clients can be simply provided with routing assistance once they have put in the products they wish to buy.

With this method all products and the place in the shop are electronically put into a central database by the shopkeeper by means of an electronic device, for example a PC, via the internet. Routers should then be installed in the shop and be linked to a local server. This local server is then to be linked to the central server which is coupled to the database.

Once the user has logged on to the central server via the local server, for example by means of a mobile communication device, for example a gsm, he or she can contact a central server via the internet, which central server is linked to the central database and he or she can put in selection criteria for selecting products. The user cannot do this, however, until he or she has downloaded an application from the internet.

Now it is possible for the user to select products on the basis of selection criteria that have been put in and navigation information will be sent via the local server and the routers to the mobile communication device of the user.

It is even possible for a user to form a list of products in advance on his or her own profile, which list is then turned on shortly afterwards to start the routing. Shops and further outlets can also utilize this service quite well.

Albeit the invention has been described in the foregoing with reference to the drawing figure, it should be observed that the invention is not by any manner or means restricted to the embodiment shown in the drawing figure. The invention also extends to all embodiments deviating from the embodiment shown in the drawing figure within the spirit and scope defined by the claims.

1. A method for people to get acquainted with one another, which method comprises:
facilitating access with an electronic appliance via the internet to a central database for putting in personal profiles:
facilitating access with a mobile communication device via the internet to a central server which is coupled to the central database, for putting in selection criteria for selecting people on the basis of the personal profiles;
facilitating downloading applications via the internet to a mobile communication device for selecting people and for navigation purposes;
selecting logged-on people in the database on the basis of selection criteria and personal profiles that have been put in;
facilitating the possibility of logging on to the central server with a mobile communication device;
computing the location of the mobile communication device from which the selection criteria have been sent and of the selected people, and sending navigation information to the mobile communication device from which the selection criteria have been sent,
characterized in that the method further includes the following steps of:
installing routers in a room,
linking the routers to a local server, and
linking via the internet the local server to the central server which is coupled to the central database,
wherein:
facilitating the possibility of logging on to the central server by means of a mobile communication device is effected by facilitating this log-on via the routers on the basis of WiFi technology and via the local server,
computing the location of the mobile communication device from which the selection criteria have been sent and of the selected people is effected in the local server on the basis of data received from these communication devices via the routers, which data are about WiFi signals received by these communication devices, and
sending navigation information to the mobile communication device from which the selection criteria have been sent is effected via the WiFi technology routers and the local server.

2. A method as claimed in claim 1, characterized in that the method further includes the step of asking the person concerned via the communication device for a remuneration for selection and navigation and the automatic cashing of the remuneration via an automatic pay system.

3. A method as claimed in claim 1 or 2, characterized in that this method further includes the step of facilitating the option of a logged-on person being able to exclude a person once spoken to from a next selection.

4. A method as claimed in any one of the preceding claims, characterized in that the method further includes the step of installing picture screens at various locations in the room and displaying on these screens commercials or messages tailored to the profile of the logged-on person who is present in the neighbourhood of the screen.

5. A method as claimed in any one of the preceding claims, characterized in that the method further includes the step of sending banners tailored to the profile of the respective person to the mobile communication device of this person.
